(19) United States
(12) Patent Application Publication
(10) Pub. No.: US 2015/0283950 A1
(43) Pub. Date: Oct. 8, 2015

(54) DEVICE FOR HOLDING A SMARTPHONE INSIDE A VEHICLE

(71) Applicant: GM GLOBAL TECHNOLOGY OPERATIONS LLC, Detroit, MI (US)

(72) Inventors: Fredrik BACKMAN, Frankfurt am Main (DE); Steffen Kuebler, Russelsheim (DE); Valter SKIBINSKI, Wallertheim (BR); Jun HYUCK EOH, Russelsheim (DE)

(73) Assignee: GM GLOBAL TECHNOLOGY OPERATIONS LLC, Detroit, MI (US)

(21) Appl. No.: 14/676,152

(22) Filed: Apr. 1, 2015

(30) Foreign Application Priority Data
Apr. 5, 2014 (DE) 102014004955.8

(51) Int. Cl. B60R 7/08; B60R 11/02; B60R 7/06

(52) U.S. Cl. CPC B60R 7/08; B60R 7/06; B60R 11/0241; B60R 2011/0005

(57) ABSTRACT

A device for holding a smartphone inside a vehicle is disclosed. The device includes a housing for receiving the smartphone and a rail for receiving the housing. The rail is connected to a dashboard or a console of the vehicle and the housing has a slot on the side facing away from the reception area for the smartphone for pushing the housing onto the rail. Such a device has a very simple design and ensures that the smartphone can he safely mounted and dismounted and that the smartphone can be securely held in the inserted condition.

### CROSS-REFERENCE TO RELATED APPLICATION

This application claims priority to German Patent Application No. 102014004955,8, filed Apr. 5, 2014, which is incorporated herein by reference in its entirety.

### TECHNICAL FIELD

This application pertains to a device for holding a smartphone inside a vehicle, and to the interior of an automobile configured to hold a smartphone therein.

### BACKGROUND

It is advantageous for the occupants of a motor vehicle, especially the driver and front-seat passenger, if a smartphone used by one of them can be securely fixed inside the vehicle while driving and can be operated easily at the same time.

A motor vehicle dashboard having a recess with two side guide rails is known from US 2007/0176797 A1. An electronic device can be inserted in the area of lateral grooves between the guide rails. This can be, for example, be a device that provides the driver and/or front-seat passenger with geographic information, such as variable-scale road maps. When it is not being used, this electronic device can be upwardly removed from the dashboard. In the inserted position, the electronic device makes contact with complementary contact points in the dashboard via contact points, so that the electronic device gets connected to a vehicle computer. Electrical energy can also be transmitted from the vehicle to the electronic device via additional contacts. A motor vehicle having a mobile telephone holder on the dashboard is also known from U.S. Pat. No. 7,062,300 B1.

### SUMMARY

In accordance with the present disclosure, a device for holding a smartphone inside a vehicle is developed which has a very simple design and ensures that the smartphone can be easily mounted and dismounted and can be securely held in the inserted condition. The device according to the present disclosure for holding the smartphone inside the vehicle has a housing for supporting the smartphone and a rail for accommodating the housing. The rail is attached to the dashboard or a console of the vehicle. The housing has a slot for sliding the housing on the rail, on a side facing away from the area of support for the smartphone.

The smartphone is held using a single rail, which works together with the housing in the area of its slot. This makes it easy to mount the smartphone, as the smartphone as held in the housing only needs to be pushed onto the rail, wherein the slot is pushed onto the rail and the housing engages in the rail there. Removing the smartphone also takes places very simple in a corresponding manner. The unit including the smartphone and the housing should be simply detached from the rail, and hence to detach the housing from the rail. In the mounted condition, that is, when the housing which accommodates the smartphone is pushed onto the rail, a secure placement of the housing and thus of the smartphone is ensured.

When the housing is not pushed onto the rail, the rail represents a visually attractive component in a clearly visible position in the vehicle. The rail is preferably aesthetically designed; for example, it is made of high quality material and has a visually appealing surface. It can, for example, also be a name plate, where the name of the vehicle type is visibly engraved or the name is affixed on the rail.

It is considered especially advantageous, if the rail and the housing have a power and/or data transmission unit. This unit enables power and/or data to be transmitted from the vehicle to the rail and from the rail to the housing and from there to the smartphone inserted in the housing. For this purpose, it is only necessary to provide the rail, the junction between the rail and housing, as well as the junction between the housing and the smartphone with the appropriate electrical contacts for power and/or data transmission.

Preferably, the contact between the rail and the housing for the transmission of power and/or data takes place in a defined sliding position of the housing on the rail. In particular, the contact takes place in a position of the housing where it is pushed on against a stopper.

Considering the aspect of high strength and also the overall aesthetic impression, it is provided that the housing is made at least partially of carbon. In particular, the portion of the housing having the slot for sliding the housing onto the rail should be made from carbon. Alternately, the housing can made entirely from carbon.

It is considered desirable, if the housing is designed as a half shell. The half shell is very well suited to accommodate the smartphone, with easy accessibility to the side of the smartphone facing away from the housing, where the control panel is usually located which is especially designed as a touch screen.

To ensure as far as possible a vibration-free placement of the smartphone while the vehicle is driven, it is preferably provided that the housing should be provided with a lining made of elastomeric material, for example an elastic rubber, for absorbing the vibrations in the area, where the smartphone is supported. Using this elastomeric material, it is possible to hold the smartphone in the housing with a certain preload to ensure that the smartphone does not come out of the housing while the vehicle is driven and when the housing starts vibrating.

The housing should be preferably designed in such way that it has two tab projections aligned with each other, on its side facing away from the support area for the smartphone. The tab projections are apart and form a slot between them. These tab projections make it possible to mount and dismount the housing easily with respect to the rail and enable a secure fixing of the housing on the rail in the inserted position of the housing, in which the housing engages behind the rail in the area of the slot. It is especially useful, if the end sections of the slot facing away are designed in such way that they extend to the end. This makes it very easy to mount the housing on the rail, because the housing can be designed with a certain tolerance with respect to the rail and the housing moves into the exact sliding position by itself when sliding over the slot designed with a taper along the sliding direction.

In particular, the rail is arranged horizontally. Weight threes of the housing and smartphone arrangement are thus applied to the rail. Only lateral forces, also forces in the longitudinal direction of the rail, need to be applied to the housing or the unit consisting of the housing and smartphone, in order to dismount the housing from the rail.

### BRIEF DESCRIPTION OF THE DRAWINGS

The present disclosure will hereinafter be described in conjunction with the following drawing figures, wherein like numerals denote like elements.

FIG. 1 shows a perspective view of an automobile in the area of a vehicle console of a first row of seats with the rail fixed to the console and with a unit including a smartphone and housing for pushing the housing onto the rail, before this unit is pushed on;

FIG. 2 shows the arrangement according to FIG. 1, after the unit include the housing and smartphone is pushed onto the rail;

FIG. 3 shows a spatial view of the unit consisting of the housing and smartphone, as seen from the back of the housing having a slot for pushing the housing onto the rail; and

FIG. 4 shows a section through the arrangement according to FIG. 2, for the area of the smartphone, cut perpendicular to the longitudinal extension of the rail.

### DETAILED DESCRIPTION

The following detailed description is merely exemplary in nature and is not intended to limit the present disclosure or the application and uses of the present disclosure. Furthermore, there is no intention to he bound by any theory presented in the preceding background of the present disclosure or the following detailed description.

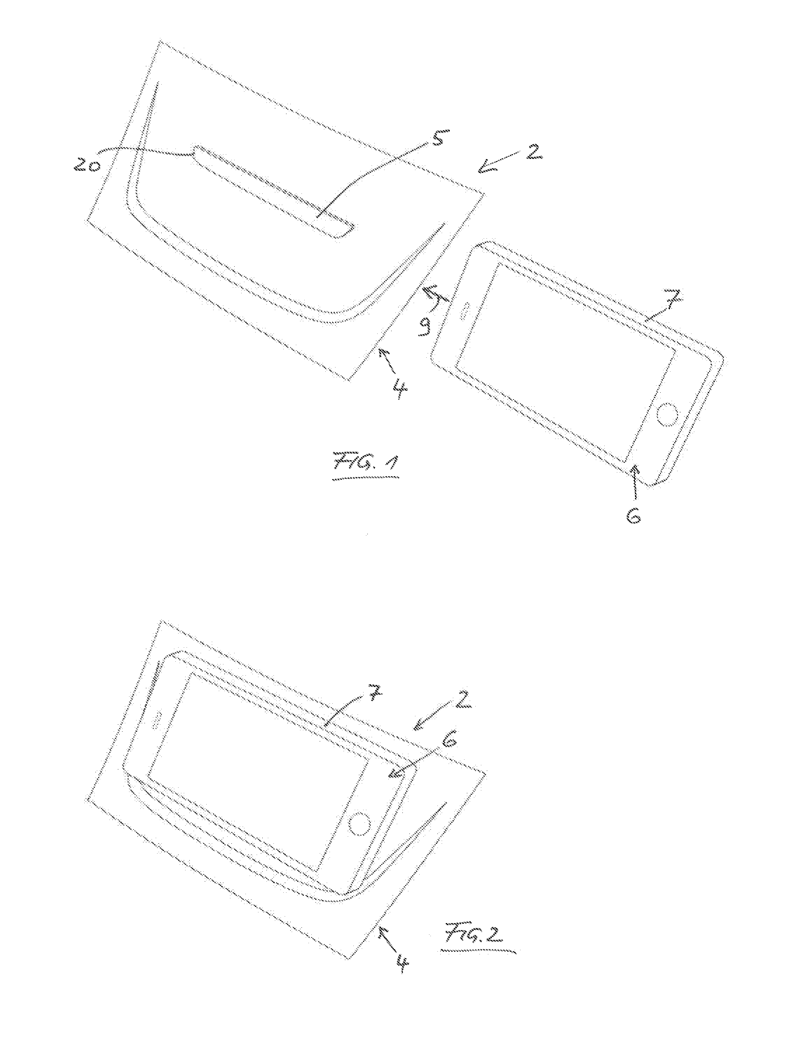

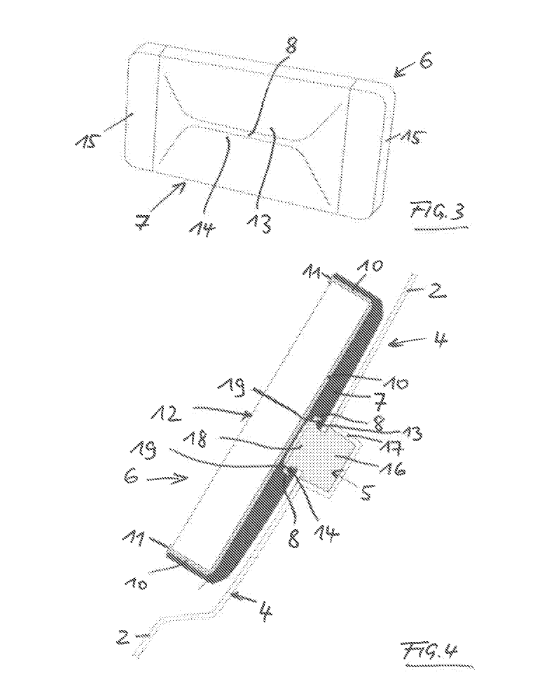

FIGS. 1 and 2 show an automobile in the area of a center console 2. With respect to the forward direction of travel, the center console 2 has a section 4 that is slightly inclined upwards in the transition to the dashboard of the automobile. In the area of this section 4, a rail 5 is connected to the center console 2. The rail 5 is mounted horizontally and transversely with respect to the forward direction of travel. The rail 5 extends to about half the width of the center console 2, and is arranged symmetrically to the center console 2. A smartphone 6, for example an iPhone®, is accommodated by a housing 7 having a slot 8 (see FIG. 3) for pushing the housing 7 onto the rail 5. FIG. 1 illustrates the smartphone 6 and housing 7 configured as a unit before it is pushed onto the rail 5 with an additional arrow 9 illustrating the direction of pushing. FIG. 2 illustrates the unit including the smartphone 6 and housing 7, after it is pushed onto the rail 5.

Reference is made below especially to the illustration in FIGS. 3 and 4. These figures show that the housing 7 is designed as a half shell. Preferably, the housing 7 includes a carbon portion. The housing 7 also has a lining 10 made from an elastomeric material, especially elastic rubber, in the reception area of the smartphone 6, for a dampened positive-fit reception of the smartphone 6. For this purpose, the lining 10 is provided with projections 11 that slightly enclose the smartphone 6 laterally on its operating side, in this case a touchscreen 12.

On the side facing away from the touchscreen 12, the housing 7 has two tab projections 13, 14 aligned with each other, which end with a gap between each other and form the slot 8 between them. In its regions facing away, the slot 8 is formed in an expanding manner respectively towards the end. The rail 5 has a base section 16 having a trapezoidal cross-section and is inserted into a correspondingly formed trapezoidal support 17 of the center console 2, and is connected therewith, for example, using an adhesive-bonded joint. A T-shaped section 18 which is also a part of the rail 5 connects to the base section 16 of the rail 5. In the area of this section 18, the tab projections 13 and 14 of the housing 7 grip the rail 5 in the pushed-on state of the housing 7.

The rail 5 and the housing 7 finally have power and data transmission units 19. When the housing 7 is pushed on, these units enable transmission of power and data from the rail 5 to the housing 7 and vice versa. The rail 5 is connected to a power and data network of the automobile through other power and data transmission units. In addition, when the smartphone 6 is inserted into the housing 7, the housing 7 is connected to the respective interfaces for power and data transmission, which are normally provided in smartphones, through power and data transfer units in housing 7. The contacting of the rail 5 and housing 7 for transmitting power and data to the takes place in a defined push-on position of the housing 7 on the rail 5, specifically when the housing 7 along with the smartphone 6 is completely pushed on the rail 5, as shown in FIG. 2. The housing 7 is moved towards a stopper 20.

As illustrated in FIG. 3, the smartphone 6 can additionally be held in an elastic frame having rubber necks |5 in the area of the narrow sides of the smartphone 6. The housing 7 is arranged between these necks 15 and receives the smartphone 6 in this housing 7.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-10. (canceled)

11. A device for holding a smartphone inside a vehicle comprising:
a rail connected to a vehicle interior component; and
a housing having a receiving area configured to receive the smartphone, the hosing having a slot formed in a side opposite the receiving area, wherein the rail is slidably received in the housing.

12. The device according to claim 11, wherein the vehicle interior component is selected from the group consisting of a dashboard and a console.

13. The device according to claim 11, wherein the rail and the housing comprise a transmission unit for transmitting at least one of a power and data therebetween.

14. The device according to claim 13, wherein the rail and the housing further comprise a contact which enables with the transmission unit when the housing is in a defined push-on position on the rail.

15. The device according to claim 14, wherein one of the housing and the rail further comprise a stopper and the contact takes place in a position of the housing pushed against the stopper.

16. The device according to claim 11, wherein the housing comprises a carbon portion.

17. The device according to claim 11, wherein the housing comprises a half shell component.

18. The device according to claim 11, wherein the receiving area of the housing comprises an elastomeric lining for the dampened support of the smartphone in the receiving area.

19. The device according to claim 11, wherein the housing comprises two tab projections aligned with each other on the side opposite the receiving area, wherein the tab projections end with a gap between each other forming the slot between them.

20. The device according to claim 19, wherein further comprises an expanding member coupled with the two tab projections for moving in an expanding manner.

21. The device according to claim 11, wherein the rail is arranged horizontally within the vehicle interior.
